(19) United States
(12) Patent Application Publication
(10) Pub. No.: US 2015/0253735 A1
(43) Pub. Date: Sep. 10, 2015

(54) Watch with Multiple Sections for Tracking Multiple Parameters

(71) Applicant: ICON Health & Fitness, Inc., Logan, UT (US)

(72) Inventor: Scott R. Watterson, Providence, UT (US)

(21) Appl. No.: 14/267,896

(22) Filed: May 1, 2014

Related U.S. Application Data
(60) Provisional application No. 61/950,590, filed on Mar. 10, 2014.

(51) Int. Cl. G04B 47/06

(52) U.S. Cl. CPC G04B 47/063

(57) ABSTRACT

A wrist watch includes a first face with a first display configured to track a physiological parameter and a second face with a second display configured to track a first time parameter.

### RELATED APPLICATIONS

This application claims priority to U.S. Provisional Application No. 61/950,590, entitled A Watch with Multiple Sections for Tracking Multiple Parameters, filed on 10 Mar. 2014; which is incorporated herein in its entirety by this reference.

### BACKGROUND

A pedometer is a wearable device that tracks the steps that a user takes over time. In some instances, the pedometer is attached to a person's belt or another location on the user's body or clothing. As the user takes a step, an accelerometer or pendulum integrated into the pedometer senses the user's movement associated with the step and increments a counter that tracks the number of steps. In additional to pedometers, other types of activity trackers can be worn around a user's wrist. Some of these activity trackers share similarities with the pedometer. For example, such activity trackers can count the movement of the user's arm as well as the movements that are related to the user's steps. One type of activity tracker is disclosed in U.S. Pat. No. 6,675,041 issued to Elisabeth N. Dickinson. In this reference, an apparatus for tracking net consumption of calories by a user has an input to allow a user to enter the number of calories in food consumed by the user. The apparatus also includes a heart rate monitor and a timer. A processor in the apparatus can calculate the number of calories expended by the user in an exercise session from the duration of the exercise session, as measured by the timer, and the intensity of the exercise session as measured by the timer. The apparatus may be provided as a light weight wrist wearable instrument. The apparatus simplifies tracking the expenditure of calories in exercise and makes it possible to vary dietary constraints on calorie consumption in accordance with the amount of exercise in which the user has participated. Another type of activity tracker is described in U.S. Pat. No. 6,823,036 issued to Yu-yu Chen.

### SUMMARY

In one aspect of the invention, a wrist watch includes a first face with a first display configured to track a physiological parameter, and a second face with a second display configured to track a first time parameter.

In one or more other aspects of the invention, the first face and the second face are incorporated into a watch portion where the watch portion is connected to a wrist band.

In one or more other aspects of the invention, the watch portion may be pivotally connected to the wrist band on a pivot side of the watch portion.

In one or more other aspects of the invention, the pivot side may be arranged to slide along a track of the wrist band.

In one or more other aspects of the invention, the watch portion further comprises a latch side opposite of the pivot side that is arranged to interlock with the wrist watch.

In one or more other aspects of the invention, the watch portion comprises a latch side opposite of the pivot side that is configured to be secured wrist band.

In one or more other aspects of the invention, the latch side is arranged to be secured to the wrist band through a magnetic connection.

In one or more other aspects of the invention, the latch side is arranged to be secured to the wrist band through a compression fit.

In one or more other aspects of the invention, the latch side is arranged to be secured to the wrist band by interlocking with a locking component of the wrist band.

In one or more other aspects of the invention, the locking component is a detent formed in the wrist band.

In one or more other aspects of the invention, may further include that the second face is further configured to track a second time parameter.

In one or more other aspects of the invention, the first time parameter and/or the second time parameter may be selected from a group of a time of day, a stopwatch, a timer, and combinations thereof.

In one or more other aspects of the invention, the physiological parameter is a heart rate parameter.

In one or more other aspects of the invention, the physiological parameter is a body movement count.

In one or more other aspects of the invention, the physiological parameter is a calorie count.

In one or more other aspects of the invention, the first face or the second face is further configured to track a distance parameter.

In one or more other aspects of the invention, the first face includes a numbered dial forming a perimeter and a pointer configured to track a body movement count during a predetermined time period.

In one or more other aspects of the invention, the first face includes a numbered dial forming a perimeter and a pointer configured to track a calorie count during a predetermined time period.

In one or more other aspects of the invention, the first face includes a numbered dial forming a perimeter and a pointer configured to track a step count during a predetermined time period.

In one or more other aspects of the invention, the first face includes a numbered dial forming a perimeter and a pointer configured to track a time of day.

In one or more other aspects of the invention, the display of the second face comprises a digital screen.

In one or more other aspects of the invention, the wrist watch may further include a multi-axis accelerometer capable of distinguishing between stepping movements and arm movements.

In one or more other aspects of the invention, the first face includes a numbered dial forming a perimeter and a pointer configured to track the physiological parameter.

In one or more other aspects of the invention, the wrist watch includes a first face with a first display configured to track a physiological parameter and to track a first time parameter.

In one or more other aspects of the invention, the wrist watch may further include a second face with a second display configured to track a second time parameter.

In one or more other aspects of the invention, the first time parameter and/or the second time parameter is selected from a first group of a time of day, a stopwatch, a timer, and combinations thereof.

In one or more other aspects of the invention, the physiological parameter is selected from a second group of a heart rate parameter, a body movement count, and a calorie count.

In one or more other aspects of the invention, the first face or the second face is further configured to track a distance parameter.

In one or more other aspects of the invention, the first face includes a numbered dial forming a perimeter and a pointer configured to track the body movement count during a predetermined time period.

In one or more other aspects of the invention, the first face includes a numbered dial forming a perimeter and a pointer configured to track the calorie count during a predetermined time period.

In one or more other aspects of the invention, the wrist watch may further include a multi-axis accelerometer capable of distinguishing between stepping movements and arm movements.

In one or more other aspects of the invention, a wrist watch includes a first face with a first display configured to track a heart rate parameter, a body movement count, a calorie count, and a first time parameter.

In one or more other aspects of the invention, the wrist watch may further include a second face with a second display configured to track a second time parameter.

In one or more other aspects of the invention, the wrist watch may further include a multi-axis accelerometer capable of distinguishing between stepping movements and arm movements.

In one or more other aspects of the invention, the first time parameter and/or the second time parameter is selected from a group of a time of day, a stopwatch, a timer, and combinations thereof.

In one or more other aspects of the invention, the first face or the second face is further configured to track a distance parameter.

In one or more other aspects of the invention, the first face includes a first numbered dial forming a first perimeter and a first pointer configured to track the body movement count.

In one or more other aspects of the invention, the first face includes a second numbered dial forming a second perimeter and a second pointer configured to track the first time parameter.

In one or more other aspects of the invention, the first face includes a third numbered dial forming a third perimeter and a third pointer configured to track the calorie count.

In one or more other aspects of the invention, a system includes a wrist watch with a watch portion and a wrist band, and further includes the watch portion comprising a first face and a second face.

In one or more other aspects of the invention, the system may further include the first face comprising a display that presents at least one tracked time parameter.

In one or more other aspects of the invention, the system may further include a processor.

In one or more other aspects of the invention, the system may further include memory in communication with the processor.

In one or more other aspects of the invention, the memory may be programmed with instructions that are executable by the processor to present at least one physiological parameter of the user in the second face.

In one or more other aspects of the invention, the instructions are further executable by the processor to track a second time parameter.

In one or more other aspects of the invention, the instructions are further executable by the processor to present the second time parameter in the second face.

In one or more other aspects of the invention, the instructions are further executable by the processor to track the at least one physiological parameter.

In one or more other aspects of the invention, the wrist watch includes a transmitter.

In one or more other aspects of the invention, the transmitter is arranged to communicate with a mobile device.

In one or more other aspects of the invention, the transmitter is arranged to communicate with a fitness tracking device.

In one or more other aspects of the invention, the transmitter is arranged to receive data about the at least one physiological parameter from a mobile device.

In one or more other aspects of the invention, the mobile device is a heart rate monitor.

In one or more other aspects of the invention, the mobile device is a wearable device comprising at least one sensor.

In one or more other aspects of the invention, the at least one physiological parameter is a heart rate.

In one or more other aspects of the invention, the system may further include at least two electrically conductive contacts arranged to detect a cardiac signal.

In one or more other aspects of the invention, at least one of the two electrically conductive contacts is located on an exposed surface of a holder of the wrist watch.

In one or more other aspects of the invention, at least one of the two electrically conductive contacts is incorporated into a floor of a holder of the wrist watch.

In one or more other aspects of the invention, the wrist band is secured to the wrist watch with a holder that is connected to the wrist band.

In one or more other aspects of the invention, the holder is arranged to expose the first face while concealing the second face.

In one or more other aspects of the invention, the holder comprises a mechanism to flip the watch portion such that the second face is exposed while the first face is concealed.

In one or more other aspects of the invention, a portion of the holder is made of an electrically conductive material.

In one or more other aspects of the invention, the watch portion is shaped to interlock with the holder.

In one or more other aspects of the invention, the watch portion is shaped to be secured in the holder through a compression fit.

In one or more other aspects of the invention, the watch portion is constructed to be secured to the holder through a magnetic connection.

In one or more other aspects of the invention, the watch portion is attached to the holder at a pivot side of the watch portion.

In one or more other aspects of the invention, the watch portion comprises a latch end that is arranged to pivot about the pivot side.

In one or more other aspects of the invention, the pivot side is configured to slide along a track formed in the holder.

In one or more other aspects of the invention, the track is formed in an inner wall of the holder.

In one or more other aspects of the invention, the watch portion is constructed to be in wireless communication with a network.

In one or more other aspects of the invention, the system may further include a wrist watch that includes a watch portion.

In one or more other aspects of the invention, the wrist portion includes a first face arranged to display a time parameter.

In one or more other aspects of the invention, the wrist portion includes a second face opposite to the first face wherein the second face is arranged to display a physiological parameter of a user.

In one or more other aspects of the invention, the system may further include a physiological sensor arranged to gather physiological data about a user.

In one or more other aspects of the invention, the physiological sensor is a heart rate sensor.

In one or more other aspects of the invention, the heart rate sensor includes at least one electrically conductive feature that is arranged to detect a cardiac signal.

In one or more other aspects of the invention, the electrically conductive feature is incorporated into a holder that secures the watch portion to a wrist band.

In one or more other aspects of the invention, the electrically conductive feature has a contact incorporated into the first face and a second contact incorporated into the second face.

In one or more other aspects of the invention, the electrically conductive feature is capable of detecting the cardiac signal when a user touches the first contact with a first region of user skin and touches the second contact with a second region of user skin simultaneously.

In one or more other aspects of the invention, the system may further include a holder with an electrically conductive portion that is positioned to make an electrical connection with the first contact when the watch portion is flipped to conceal the first face and with the second contact when the watch portion is flipped to conceal the second contact.

In one or more other aspects of the invention, the system may further include the electrically conductive portion of the holder is also positioned to contact a portion of user skin on an arm, wrist, or hand of the user, wherein a cardiac signal is capable of passing through the electrically conductive portion of the holder and the first contact or second contact.

In one or more other aspects of the invention, the system may further include a wrist watch that includes a watch portion.

In one or more other aspects of the invention, a wrist watch includes a first face arranged to display a time parameter, and a second face opposite to the first face and arranged to display a physiological parameter of a user.

In one or more other aspects of the invention, the wrist watch may further include input/output resources arranged to communicate with a remote computing device.

In one or more other aspects of the invention, the input/output resources are arranged to gather physiological data about a user.

In one or more other aspects of the invention, the input/output resources are arranged to send physiological data about a user to a fitness tracking device.

In one or more other aspects of the invention, the fitness tracking device is a cloud based device.

In one or more other aspects of the invention, the input/output resources are arranged to communicate with the fitness tracking device through a mobile device.

In one or more other aspects of the invention, the fitness tracking device is configured to store the data about the physiological data in an accessible format to the user.

In one or more other aspects of the invention, the input/output resources are arranged to send physiological data about a user to a mobile device.

In one or more other aspects of the invention, the input/output resources are arranged to communicate with a heart rate monitor.

In one or more other aspects of the invention, the input/output resources are arranged to communicate with a mobile device.

In one or more other aspects of the invention, the input/output resources are arranged to communicate with a wearable computing device.

In one or more other aspects of the invention, the input/output resources are arranged to be in communication with a network.

In one or more other aspects of the invention, the network comprises a storage device that is capable of storing data sent from the wrist watch.

In one or more other aspects of the invention, the input/output resources are arranged to send heart rate data the remote computing device.

In one or more other aspects of the invention, the input/output resources are arranged to send calorie data the remote computing device.

In one or more other aspects of the invention, the input/output resources are arranged to send body movement data the remote computing device.

In one or more other aspects of the invention, the input/output resources are arranged to send step data the remote computing device.

In one or more other aspects of the invention, the input/output resources are arranged to send arm movement data the remote computing device.

In one or more other aspects of the invention, a wrist watch includes a first face with a first display configured to track a physiological parameter in a non-digital format, and a second face with a second display configured to track a first time parameter.

In one or more other aspects of the invention, the second face is positioned to be concealed against a user's skin when the first face is exposed.

In one or more other aspects of the invention, the second face is arranged to be on an opposite side of the watch to the first face.

In one or more other aspects of the invention, the physiological parameter is a heart rate.

In one or more other aspects of the invention, the physiological parameter is a calorie count.

In one or more other aspects of the invention, the physiological parameter is a body movement count.

In one or more other aspects of the invention, the body movement count is a step count.

In one or more other aspects of the invention, the body movement count is an arm movement count.

In one or more other aspects of the invention, the wrist watch may further include a transmitter in communication with a remote physiological sensor.

In one or more other aspects of the invention, the remote physiological sensor is a heart rate sensor.

In one or more other aspects of the invention, the non-digital format comprises a numbered dial.

In one or more other aspects of the invention, the numbered dial forms a perimeter.

In one or more other aspects of the invention, the non-digital format comprises displaying multiple physiological parameters, each with separate numbered dials.

In one or more other aspects of the invention, the first face also tracks at least one time parameter.

In one or more other aspects of the invention, a wrist watch may include a first face that tracks a first parameter, and a second face that tracks a second parameter.

In one or more other aspects of the invention, the wrist watch may further include an input mechanism that controls at least one aspect of the first face and the second face.

In one or more other aspects of the invention, the first parameter is a time parameter and the second parameter is a physiological parameter.

In one or more other aspects of the invention, the physiological parameter is a heart rate.

In one or more other aspects of the invention, the physiological parameter is a calorie count.

In one or more other aspects of the invention, the physiological parameter is a body movement count.

In one or more other aspects of the invention, the body movement count is a step count.

In one or more other aspects of the invention, the body movement count is an arm movement count.

In one or more other aspects of the invention, the input mechanism is a button.

In one or more other aspects of the invention, the input mechanism is a rotary dial.

In one or more other aspects of the invention, a lengthwise position of the rotary dial determines which parameter the input mechanism controls.

In one or more other aspects of the invention, multiple lengthwise positions of the rotary dial are arranged to control different parameters tracked by the first face.

In one or more other aspects of the invention, multiple lengthwise positions of the rotary dial are arranged to control different parameters tracked by the second face.

In one or more other aspects of the invention, a lengthwise position of the rotary dial determines a mode of the wrist watch.

In one or more other aspects of the invention, the input mechanism is a button and a rotary dial that are both arranged to control parameters on both the first face and the second face.

Any of the aspects of the invention detailed above may be combined with any other aspects of the invention detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of a first side of a wrist watch in accordance with the present disclosure.

FIG. 2 illustrates a perspective view of a second side of the wrist watch of FIG. 1.

FIG. 3 illustrates a block diagram of a tracking system in accordance with the principles described in the present disclosure.

FIG. 4 illustrates a front view of an example of a wrist watch in accordance with the present disclosure.

FIG. 5 illustrates a front view of an example of a wrist watch in accordance with the present disclosure.

FIG. 6 illustrates a front view of an example of a wrist watch in accordance with the present disclosure.

FIG. 7 illustrates a front view of an example of a wrist watch in accordance with the present disclosure.

FIG. 8 illustrates a front view of an example of a wrist watch in accordance with the present disclosure.

FIG. 9 illustrates a front view of an example of a wrist watch in accordance with the present disclosure.

FIG. 10 illustrates a front view of an example of a wrist watch in accordance with the present disclosure.

FIG. 11 illustrates a front view of an example of a wrist watch in accordance with the present disclosure.

FIG. 12 illustrates a front view of an example of a wrist watch with an accessory item in accordance with the present disclosure.

FIG. 13 illustrates a front view of an example of a wrist watch with an accessory item in accordance with the present disclosure.

FIG. 14 illustrates a front view of an example of a wrist watch in process of switching between a first face and a second face in accordance with the present disclosure.

FIG. 15 illustrates a front view of an example of a wrist watch in accordance with the present disclosure.

FIG. 16 illustrates a front view of an example of a wrist watch in accordance with the present disclosure.

FIG. 17 illustrates a side view of an example of a wrist watch in accordance with the present disclosure.

FIG. 18 illustrates a perspective view of an example of a wrist watch in accordance with the present disclosure.

FIG. 19 illustrates a perspective view of an example of a wrist watch in accordance with the present disclosure.

FIG. 20 illustrates a perspective view of an example of a wrist watch in accordance with the present disclosure.

FIG. 21 illustrates a perspective view of an example of a wrist watch in accordance with the present disclosure.

FIG. 22 illustrates a perspective view of an example of a wrist watch in accordance with the present disclosure.

FIG. 23 illustrates a perspective view of an example of a wrist watch in accordance with the present disclosure.

FIG. 24 illustrates a perspective view of an example of a wrist watch in accordance with the present disclosure.

FIG. 25 illustrates a side view of an example of a wrist watch in accordance with the present disclosure.

FIG. 26 illustrates a side view of an example of a wrist watch in accordance with the present disclosure.

Throughout the drawings, identical reference numbers designate similar, but not necessarily identical, elements.

### DETAILED DESCRIPTION

Pedometers or other kinds of activity trackers provide the user with helpful information that allows the user to make decisions about how active the user ought to be to reach fitness goals. The activity trackers can include a display that shows information such as the estimated number of calories burned or other types of units intended to measure energy consumption. However, the user may desire to track some specific parameters during the course of a workout without disrupting the overall count of the same parameter over a longer period of time.

The principles described in the present disclosure include a wrist watch that provides the user with an ability to track parameters over overlapping time periods. For example, the user may desire to track the number of calories burned during a workout while also tracking the number of calories burned over the course of the entire day. The principles described herein provide a wrist watch with a first face that is configured to track at least one time parameter or physiological parameter during a first time period and a second face that is configured to track at least one time parameter or physiological parameter over a second time period. Further, at least some of the parameters on the first and second face can also overlap. However, in some instances the parameters tracked by the first face are different than the parameters tracked by the second face.

By using a wrist watch that can track parameters for different time periods, the user can track information that is specific to the user's workouts without disrupting measurements that are intended to be taken over a longer period of time. Thus, the user does not have to reset the time or physiological parameter counts that are measuring daily activity when desiring to track the time or physiological parameters during a workout. Further, the user does not have to use multiple activity trackers to avoid restarting the daily count. The principles described in the present disclosure allow the user to use a single activity tracker to track these parameters during different time periods simultaneously.

The displays of the wrist watch on the first side and the second side can also be customized for the activities intended by the user. For example, the side of the watch that is intended for measuring workout parameters can be displayed in an easy to see format. For example, the parameters can be tracked in a digital format. Further, the inputs on the side of the wrist watch intended for workouts can be simple and intuitive to use. For example, the display on the face intended for workouts can include a start/stop button, touch screen buttons, and other features that are intuitive and easy to use under the conditions of a workout.

The side of the wrist watch that is intended to track a longer period of time, such as the entire day, can be presented in a manner that may be more appropriate for business meetings, public appearances, interviews, and other activities that can occur throughout the user's day. This side of the wrist watch may incorporate mechanisms for displaying the measured parameters in more classy, formal, or sophisticated ways. For example, the measured parameters may be presented with a circular analog dial and a pointer that points to the region of the circular dial that corresponds with the current count of the tracked parameter.

For purposes of this disclosure, the terms “minimum” and “maximum” represent the boundaries of selected ranges that the tracking devices of the wrist watch record. Such boundaries may be inherent with certain types of tracking devices. However, such minimums and maximums do not place limitations on the physiological parameters that they measure.

Further, for purposes of this disclosure, a “numbered dial” refers to a mechanism with a surface that includes multiple progressive symbols that can be pointed to, highlighted, or otherwise emphasized to indicate a value of a parameter. For example, the numbered dial may include a progressive series of numbers that form a row, a line, a column, a perimeter, a shape, or combinations thereof. In other examples, the numbered dial may include marks or other symbols that represent numbers although the numbers are not displayed on the dial.

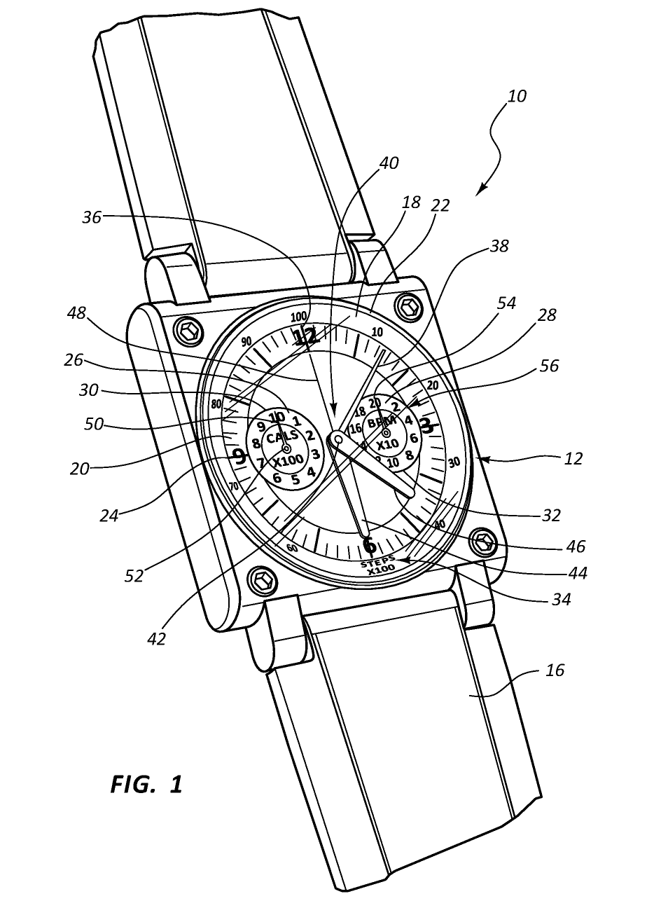

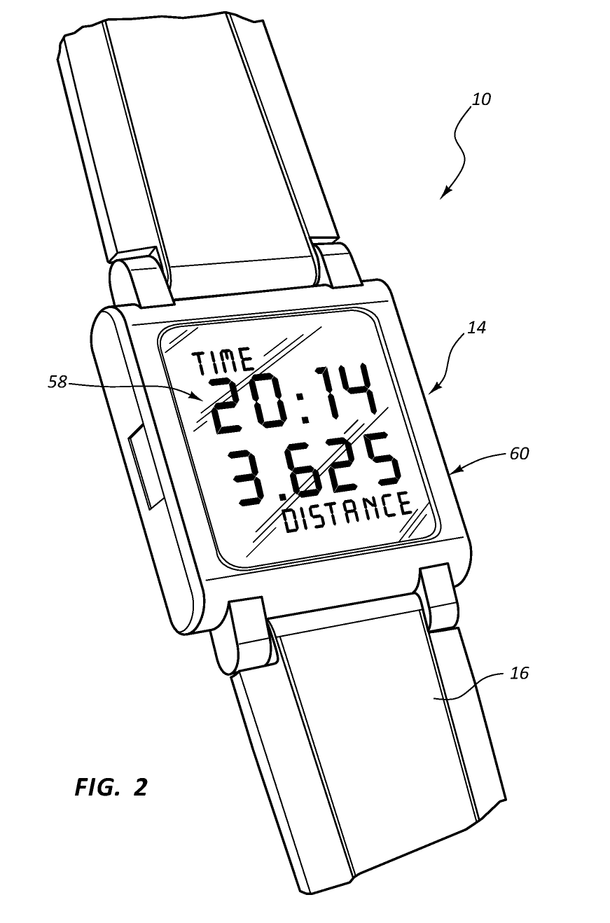

Particularly, with reference to the figures, FIGS. 1 and 2 depict a wrist watch 10 that can track time parameters and physiological parameters. FIG. 1 depicts a first face 12 of the wrist watch 10, and FIG. 2 depicts a second face 14 of the wrist watch 10 of FIG. 1. In this example, the first face 12 can be used to track parameters over a first period of time, such as a day, while the second face 14 can be used to track parameters of a shorter period of time, such as during a workout.

During the course of the day, the user can wear the wrist watch 10 with the first face 12 facing up while the second face 14 is concealed against the user's wrist. In this manner, the user can conveniently view the first face 12 to determine the parameters that are being tracked over the course of the day. When the user desires to workout, the user can flip the wrist watch 10 over to view the second face 14 to determine the parameters that are being tracked during the workout.

In some examples, the wrist band 16 is constructed to allow the user to fasten the band ends together with either face of the wrist band facing away from the user's wrist. However, in other examples, the first and second faces 12, 14 of the wrist watch 10 can be detached from the wrist band 16 and reconnected when the user desires to view a different face. For example, the user may snap out a watch portion from the wrist band 16, flip the watch portion over, and snap the watch portion back into a fixture held by the wrist band 16. In yet other examples, the wrist watch 10 is configured to rotate about a pivot shaft with respect to the wrist band 16. In such an example, the first and second faces 12, 14 of the wrist watch 10 can be changed while the wrist band 16 maintains its original orientation with respect to the user's wrist.

The first face 12 of the wrist watch 10 may be constructed to have a classy or professional appearance. In this manner, the user can wear the wrist watch 10 throughout the day in many different settings and continue to monitor the parameters of the first face 12. The appearance of the first face 12 may include any appropriate type of tracking mechanism that provides the user's desired look. For example, the first face 12 may include at least one numbered dial and a pointer. In the example of FIG. 1, the first face 12 includes a first numbered dial 18 and a second numbered dial 20. The first numbered dial 18 forms a first perimeter 22 around a portion of the first face 12. Likewise, the second numbered dial 20 also forms a second perimeter 24. In this example, the first numbered dial 18 and the second numbered dial 20 are concentric to one another and also form the first and second perimeters 22, 24 around overlapping portions of the first and second number dials 18, 20. In this example, the portion of the first face 12 circumscribed by the first perimeter 22 is slightly larger than the portion circumscribed by the second perimeter 24.

In addition to the first and second numbered dials 18, 20, the first face 12 also includes a third numbered dial 26 and a fourth numbered dial 28. The third numbered dial forms a third perimeter 30 around another portion of the first face 12. Likewise, the fourth numbered dial 28 forms a fourth perimeter 32 around yet another portion of the first face 12. In this example, the third and fourth perimeters 30, 32 circumscribe areas of the first face 12 that do not overlap. However, the areas circumscribed by the third and fourth perimeters 30, 32 do overlap with the portions of the first face 12 that are circumscribed by the first and second perimeters 22, 24.

In this example, the numbered dials 18, 20, 26, 28 generally form circular perimeters. However, any appropriate type of perimeter may be formed by the numbered dials 18, 20, 26, 28. For example, at least one of the numbered dials 18, 20, 26, 28 may form a rectangular perimeter, a square shaped perimeter, a triangular perimeter, an elliptical perimeter, a partial perimeter, another type of perimeter, or combinations thereof. In some examples, at least one of the numbered dials 18, 20, 26, 28 does not form a perimeter. For example, the numbered dial may have a linear shape, a semi-circular shape, an arc segment shape, another type of shape, or combinations thereof. Further, while this example has been described with reference to four different numbered dials, any appropriate number of dials may be used. The number of dials in the first face 12 may correspond to the number of parameters being tracked by the first face 12.

In the example of FIG. 1, the first numbered dial 18 tracks a number of steps taken by the user over the course of a day. The first numbered dial 18 is identified with a step label 34 stating “Steps X100” along a segment of the perimeter to assist the user in identifying which parameter is being tracked by the first numbered dial. The first numbered dial 18 includes a step reference point 36 that simultaneously represents the minimum count and the maximum count of steps measured by the first numbered dial 18. In this example, the minimum count corresponds to zero steps and the maximum count corresponds to 10,000 steps. The first numbered dial 18 also includes periodic numerical indicators that correspond to step counts. As indicated by the step label 34, each of the numerical indicators are to be multiplied by 100 to determine the number of steps taken. However, any scaling multiplier may be used to perform the desired parameter tracking.

A first pointer 38 may include a pivot end 40 pivotally attached to a center 42 of the first face 12. As the wrist watch 10 determines that the user has performed a stepping movement, the wrist watch 10 may increment the record of tracked steps by rotating the first pointer 38 to the appropriate number. In some examples, the first pointer 38 may move in response to each recorded step. In other examples, the first pointer 38 may move in response to a predetermined number of steps, especially in examples where the maximum number of steps tracked by the first numbered dial is large. In such examples, the wrist watch may include a memory and a processor that are capable of electronically storing the step count in a digital library. In some examples, such a memory and a processor are in communication with a remote computing device and at least some of the storing or processing of the number of steps occurs at the remote computing device. In some examples, the remote computing device may be a server, a laptop, a phone, an electronic tablet, another type of mobile device, a wearable computing device, a fitness tracking device, a cloud based device, another type of device, or combinations thereof.

In some examples, the tracked steps are tracked for a predetermined period of time, such as a day. The wrist watch 10 may include the capability of automatically resetting the first numbered dial 18 to the minimum steps count at the end of a day or other predetermined period of time. In other examples, the steps are continuously tracked without regard for the beginning and end of a specific period of time, or until manually reset by the user.

The wrist watch 10 may include an accelerometer which can measure movements of the user's body to determine the number of steps taken by the user. In some examples, the accelerometer is a multi-axis accelerometer that has the capability of distinguishing between stepping movements of the user, arm movements of the user, or other movements of the user. For example, the accelerometer may record a pattern of vertical movements that occur at a substantially regular rate. The accelerometer or a processing device in communication with the accelerometer may determine that such a pattern represents walking and that each of the vertical changes represents a step. Further, the accelerometer or a processing device in communication with the accelerometer may have an ability to recognize patterns that exhibit arm movements or types of body movements. As a result, the wrist watch 10 may have the capability of incrementing the first numbered dial 18 in response to recognizing a movement that corresponds with a step while leaving the first numbered dial 18 unaltered in response to recognizing another type of body movement that does not correspond to stepping.

The second numbered dial 20 tracks a time of day. In this example, multiple pointers are used to track the time of day. A second pointer 44 tracks the hours in the day, a third pointer 46 tracks the minutes in the hour, and a fourth pointer 48 tracks the seconds in the minute. Each of the pointers 38, 44, 46, 48 may include a different visual appearance to aid the user in determining which pointer is tracking which parameter.

The time of day may be tracked with a mechanical counting mechanism, an electronic counting mechanism, or another type of mechanism. In some examples, the wrist watch 10 is in communication with a remote computing device that tracks the time of day and conveys time information to the wrist watch 10.

The third numbered dial 26 tracks a calorie count. The third numbered dial 26 include a calories reference point 50 that simultaneously represents both a minimum count and a maximum count. In this example, the minimum count is zero calories and the maximum count is 1,000. However, any number of maximums and minimums may be incorporated into the third numbered dial 26. Numerical indicators are spaced along the third numbered dial which correspond to the amount of calories estimated to be burned by the user during the day. The third numbered dial 26 also includes a calories label, which indicates that the numerical indicators are to be multiplied by 100 to determine the calorie count. A calorie pointer 52 rotates about a pivot end and points to the numerical indicator that represents the current calorie count.

The calorie count may be at least partially based on the body movements of the user that are tracked with the accelerometer. In such an example, the wrist watch may use any appropriate calculation to estimate a number of calories burned by the user in response to body movements. For example, the wrist watch 10 may assume that each movement of the user is a predetermined fraction of a calorie. In other examples, the wrist watch 10 associates a higher calorie count to certain kinds of movements. In such an example, the wrist watch 10 may associate a higher calorie burn for leg movements than arm movements because leg movements move the entire weight of the body while arm movements may be moving just the weight of the arm.

Other sensors may be incorporated into the wrist watch to aid in determining the number of calories burned by the user. For example, a heart rate monitor may be incorporated into the wrist watch 10 to determine how hard the user is working. Further, the wrist watch may analyze the patterns from the accelerometer to determine how fast a user is walking. If the pattern reveals that a person is taking steps at a faster rate, the wrist watch 10 may associate a greater intensity of work being performed by the user and adjust the calorie count estimate accordingly. Further, the wrist watch 10 may be in communication with other devices that are intended to measure other physiological parameters of the user that can be used as factors for determining the calorie count. For example, a thermometer may be positioned on the user to determine a temperature of the user. Likewise, an oxygen analyzer that measures the user's oxygen consumption may also be in communication with the wrist watch 10. While these examples have been described with reference to specific devices and mechanisms that may be used in whole or in part for determining a calorie count, any appropriate mechanism for determining and/or estimating the user's calorie count may be used in accordance with the principles described in the present disclosure.

In some embodiments, the calorie count includes an estimated basal metabolic calorie count and an activity calorie count. To determine the basal metabolic calorie count, the wrist watch may use information about the user. For example, the wrist watch 10 may request from the user information such as age, gender, height, weight, and other types of information that may be useful for determining the user's basal metabolic calorie count.

The fourth numbered dial 28 in the exemplary embodiment tracks a heart rate. Numerical indicators are spaced along the fourth perimeter 32. A heart rate reference point 54 simultaneously represents both the minimum heart rate and the maximum heart rate that will be tracked by the forth numbered dial 28. In this example, the minimum heart rate is zero beats per minute, and the maximum heart rate is 200 beats per minute. However, any number of maximums and minimums may be incorporated into the fourth numbered dial 28. The exemplary fourth numbered dial 28 includes a heart rate label 56 that indicates that the numerical indicators are to be multiplied by ten to determine the current heart rate.

A heart rate monitor may be incorporated into the wrist watch 10 or in the wrist band 16 and be positioned proximate a region of the user's arm and/or wrist that can sense blood flow, such as through the user's pulse. In other examples, a heart rate monitor is positioned elsewhere on the user's body and is in remote communication with the wrist watch 10. In yet other examples, the heart rate monitor may measure a characteristic associated with capillary exchange, bioelectrical signals, blood pressure changes, blood volume change, acoustic signals, other types of signals, or combinations thereof to determine the heart rate.

The first face 12 of the wrist watch 10 may measure any appropriate type of parameter. Other types of parameters that may be tracked by the first face 12 may include, but are not limited to, a breath rate, a distance traveled, a stopwatch, an arm movement count, another type of body movement count, a body temperature, a thermal characteristic of the body, a nutritional characteristic of the body, an electrical property of the body, a magnetic property of the body, a chemical property of the body, a pressure characteristic of the body, an average heart rate, a measured high heart rate, a measured low heart rate, a blood oxygen level, an ambient temperature, an atmospheric pressure, an ambient humidity, another atmospheric condition, an altitude, a current speed, a maximum measured speed, a sleep parameter, a fat loss parameter, a heart rate zone parameter, another type of characteristic of the body, or combinations thereof. Sensors for determining these types of parameters may be incorporated directly into the wrist watch 10 or such sensors may be in remote communication with the wrist watch 10. Further, the wrist watch 10 may include other features, such email features, texting features, calendar feature, contact features, alarm features, camera features, weather features, alert features, map features, direction features, compass features, location features, other types of features, or combinations thereof.

While the examples above have been described with specific reference to the first face of the wrist watch having numbered analog dials to track time and physiological parameters of the user, any appropriate type of mechanism may be used to track such time and physiological parameters. For example, digital mechanisms, backlight mechanisms, icon mechanisms, light emitting diode (LED) mechanisms, color mechanisms, other types of mechanisms, or combinations thereof may be used in lieu of or with the numbered analog dials described above.

In addition to the parameters that are tracked with the first face 12 of the wrist watch 10, the second face 14 may also track both time and physiological parameters of the user. The parameters tracked by the second face 14 may overlap partially or entirely with the parameters tracked by the first face 12. For example, both the first face 12 and the second face 14 may track a time of day, a calorie count, a step count, another type of parameter, or combinations thereof. However, in other examples, the parameters measured by the first face 12 do not overlap with the parameters measured by the second face 14. Thus, in such examples, each type of parameter is exclusively tracked and/or displayed in a single face.

In the example of FIG. 2, a stopwatch parameter is tracked with a digital time indicator 58 in a digital screen. In this example, the digital time indicator 58 displays the time from the moment that the stopwatch began. The stopwatch may be started or stopped with any appropriate mechanism. For example, a button incorporated into the side of the wrist watch 10, a touch screen button, a voice activation mechanism, or another type of input mechanism may be used to start and stop the stopwatch parameter or to control another function of the wrist watch 10. Other time parameters may be tracked with the second face 14, such as a time of day, a countdown timer, other types of time parameters, or combinations thereof.

In the illustrated example, the second face 14 also includes a digital distance indicator 60. The distance traveled from the time that the distance indicator is activated is displayed in the second face 14. The start and/or stop mechanism for the stopwatch may also be used to start and stop the distance indicator 60 or other types of indicators. In other examples, the distance parameter and the stopwatch parameter are tracked with different start and stop mechanisms. The distance parameter may be measured with a global positioning unit incorporated into the wrist watch 10 or located elsewhere on the person's body. In other examples, the wrist watch 10 calculates the user's stride with the number of steps taken to determine a distance traveled.

Any of the parameters described in conjunction with the first face 12 may be incorporated into the second face. Such parameters may be tracked in the second face 14 with digital mechanisms, backlight mechanisms, icon mechanisms, LED light mechanisms, color mechanisms, numbered dial mechanisms, other types of mechanisms, or combinations thereof. The parameters tracked with the second face 14 may be arranged for functionality that is intuitive and convenient for use during a workout.

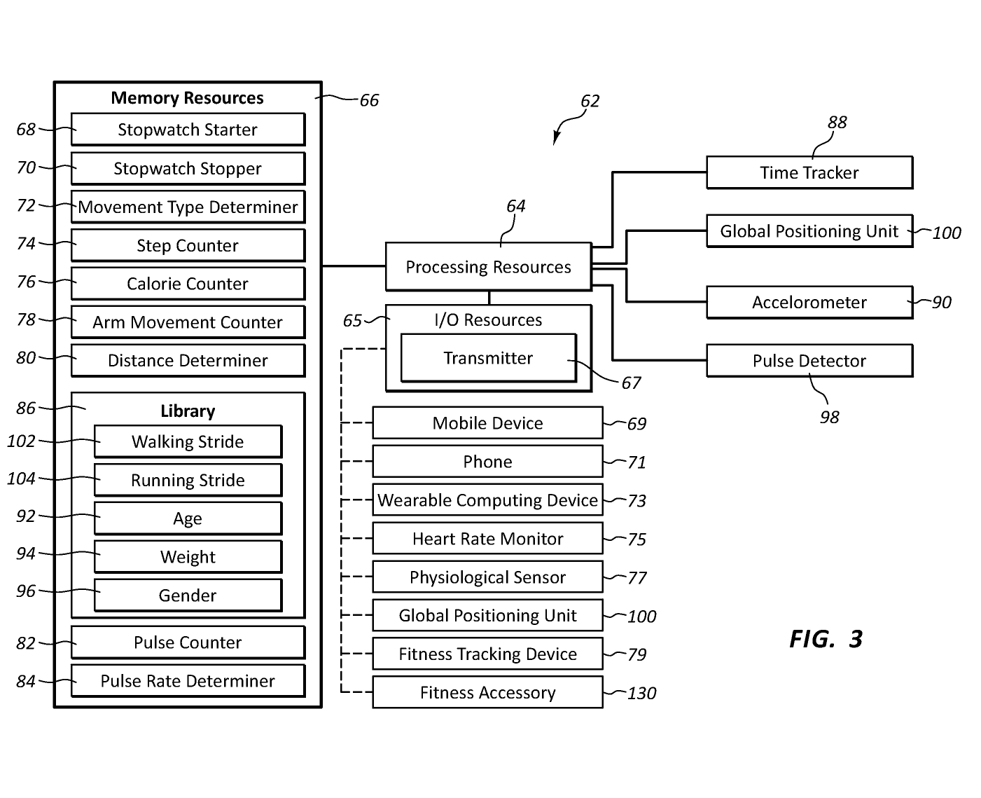

FIG. 3 illustrates a block diagram of a tracking system 62 in accordance with the principles described in the present disclosure. The tracking system 62 may include a combination of hardware and programmed instructions for executing the functions of the tracking system 62. In this example, the tracking system 62 includes processing resources 64 that are in communication with memory resources 66. Processing resources 64 include at least one processor and other resources used to process the programmed instructions. The memory resources 66 represent generally any memory capable of storing data such as programmed instructions or data structures used by the tracking system 62. The programmed instructions shown stored in the memory resources 66 include a stopwatch starter 68, a stopwatch stopper 70, a movement type determiner 72, a step counter 74, a calorie counter 76, an arm movement counter 78, a distance determiner 80, a pulse counter 82, and a pulse rate determiner 84. The data structures shown stored in the memory resources 66 include a library 86.

The memory resources 66 include a computer readable storage medium that contains computer readable program code to cause tasks to be executed by the processing resources 64. The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic storage media, other types of memory, or combinations thereof.

The stopwatch starter 68 represents programmed instructions that, when executed, cause the processing resources 64 to start a time tracker 88. The stopwatch stopper represents programmed instructions that, when executed, cause the processing resources 64 to stop the time tracker 88. The time tracker may be a stopwatch, a countdown timer, another type of time tracker, or combinations thereof.

The movement type determiner 72 represents programmed instructions that, when executed, cause the processing resources 64 to determine the type of movement executed by the user based on the outputs from the accelerometer 90. If the movement type determiner 72 classifies a movement as a stepping movement, the processing resources can cause the step counter 74 to increase to reflect the number of steps taken by the user. Likewise, if the movement type determiner 72 classifies a movement as an arm movement, the processing resources can cause the arm movement counter 78 to increase to reflect the number of arm movements executed by the user. In some examples, the movement type determiner 72 can classify the movements as other types of movements, such as back movements, jumping movements, abdominal movements, core movements, other types of movements, or combinations thereof.

The calorie counter 76 represents programmed instructions that, when executed, cause the processing resources 64 to count the number of calories burned by the user. The calories counter 76 may draw from the step counter 74, the arm movement counter 78, or another type of counter to determine the calorie count. Additionally, the calorie counter 76 may also draw from the library 86 to ascertain some of the variables used to calculate the calories burned, such as an age parameter 92, a weight parameter 94, a gender parameter 96, another type of parameter, or combinations thereof. Further, the calorie counter 76 may also draw from an output of the pulse rate determiner 84.

The pulse counter 82 represents programmed instructions that, when executed, cause the processing resources 64 to count the number of beats measured from the user's pulse over a predetermined period of time with a pulse detector 98. The pulse rate determiner 84 represents programmed instructions that, when executed, cause the processing resources 64 to determine the pulse rate based on the pulse count measured with the pulse counter 82.

The distance determiner 80 represents programmed instructions that, when executed, cause the processing resources 64 to determine a distance traveled by the user. In some examples, the distance determiner 80 obtains information from a global positioning unit 100 to determine, at least in part, the distance travel by the user. In other examples, the distance determiner 80 obtains information from the step counter 74 and information from the library 86. Such information from the library 86 may include a walking stride parameter 102 and/or a running stride parameter 104 of the user. The distance determiner 80 may determine, based on output from the accelerometer, whether the user is running or walking and collect the steps taken by the user. In such an example, the distance determiner 80 may multiply the appropriate stride with the number of counts to determine a distance traveled.

Further, the memory resources 66 may be part of an installation package to be downloaded to the wrist watch 10. In response to installing the installation package, the programmed instructions of the memory resources 66 may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed in the wrist watch 10. Here, the memory resources 66 can include integrated memory such as a hard drive, a solid state hard drive, or the like.

The processing resources 64 may be in communication with input/output (I/O) resources 65. Such I/O resources 65 may include a transmitter 67 that is configured to communicate with remote computing devices. In some examples, the remote computing devices send information to the I/O resources 65. However, in other examples, the I/O resources 65 send information to the remote computing devices.

Any appropriate type of transmitter 67 may be used in accordance with the principles described in the present disclosure. For example, the transmitter 67 may be a radio transmitter, an optical transmitter, an acoustic transmitter, an antenna, another type of transmitter, or combinations thereof. Additional, any appropriate type of remote computing device may be in communication with the I/O resources 65, such as a mobile device 69, a phone 71, a wearable computing device 73, a heart rate monitor 75, a physiological sensor 77, a global positioning unit 100, a fitness tracking device 79, a fitness accessory 130, a digital device, another type of remote computing device, or combinations thereof.

The fitness tracking device 79 may be a remote server or a cloud based device that stores fitness data about the user. For example, the fitness tracking device 79 may include a user profile that includes the user's age, weight, height, gender, running stride, walking stride, other types of personal data, or combinations thereof. Further, the fitness tracking device 79 may include the historical activities of the user. For example, the fitness tracking device 79 may include data about the workouts that the user has performed over time, the number of calories burned, the distance run, the user's movement count, the user's historical heart rate, the amount of weight lifted, the number of lift repetitions, other types of fitness data, sleep data, nutrition data, medical condition data, other types of data, or combinations thereof. The fitness tracking device 79 may be wired or wirelessly accessible to the user over the internet. As a result, the user may be able to access such information through his or her mobile device, electronic tablet, laptop, desktop, smart phone, other type of device, or combinations thereof. In this manner, the user can retrieve historical information about his or her workout. In some examples, the user has an option to share at least some of his or her fitness data with friends that also use a fitness tracking program associated with the fitness tracking device 79. In such an example, the user can remotely compete with friends and family in athletic activities. An example of a fitness tracking program that may be associated with the fitness tracking device is the iFit program, which can be found at www.ifit.com (last visited Apr. 25, 2014). The iFit program is available through ICON Health and Fitness, Inc. located in Logan, Utah, U.S.A.

In some examples, the processing resources 64 and the memory resources 66 are located within the wrist watch 10. The memory resources 66 may be part of the wrist watch's main memory, caches, registers, non-volatile memory, or elsewhere in the wrist watch's memory hierarchy. Alternatively, the memory resources 66 may be in communication with the processing resources 64 over a network. In such an example, some of the memory resources 66 may be located in one of the remote computing devices. Further, the data structures, such as the library 86, may be accessed from a remote location over a network connection while the programmed instructions are located locally.

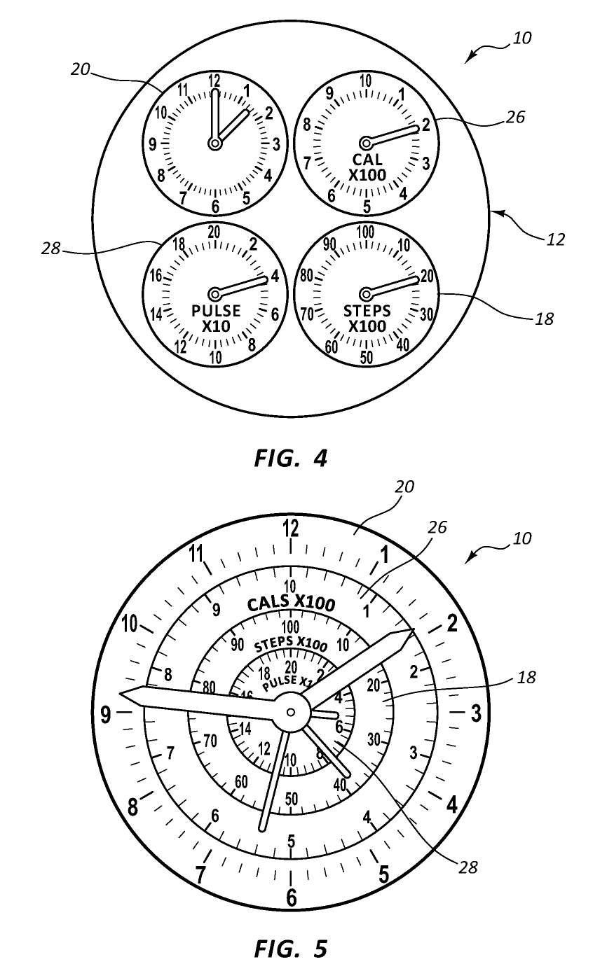

FIG. 4 illustrates a front view of an example of a wrist watch 10 in accordance with the present disclosure. In this example, the first face 12 of the wrist watch includes the first numbered dial 18 for tracking the steps, the second numbered dial 20 for tracking the time of day, the third numbered dial 26 for tracking the calorie count, and the fourth numbered dial 28 for tracking the heart rate. Each of the numbered dials includes perimeters that circumscribe areas of the first face 12. In this example, none of the circumscribed areas from each of the numbered dials 18, 20, 26, 28 overlap with each other. Further, in the illustrated example, none of the pointers associated with different numbered dials share a common pivot axis. However, in another example, detailed below with reference to FIG. 5, the various pointers may share a common pivot axis.

FIG. 5 illustrates a front view of an example of a wrist watch 10 in accordance with the present disclosure. In this example, each of the numbered dials 18, 20, 26, 28 are concentric with each another. Further, each of the pointers associated with the different numbered dials 18, 20, 26, 28 share a common pivot axis. Additionally, the areas of the first face 12 that are circumscribed by the perimeters of the different numbered dials overlap with each other.

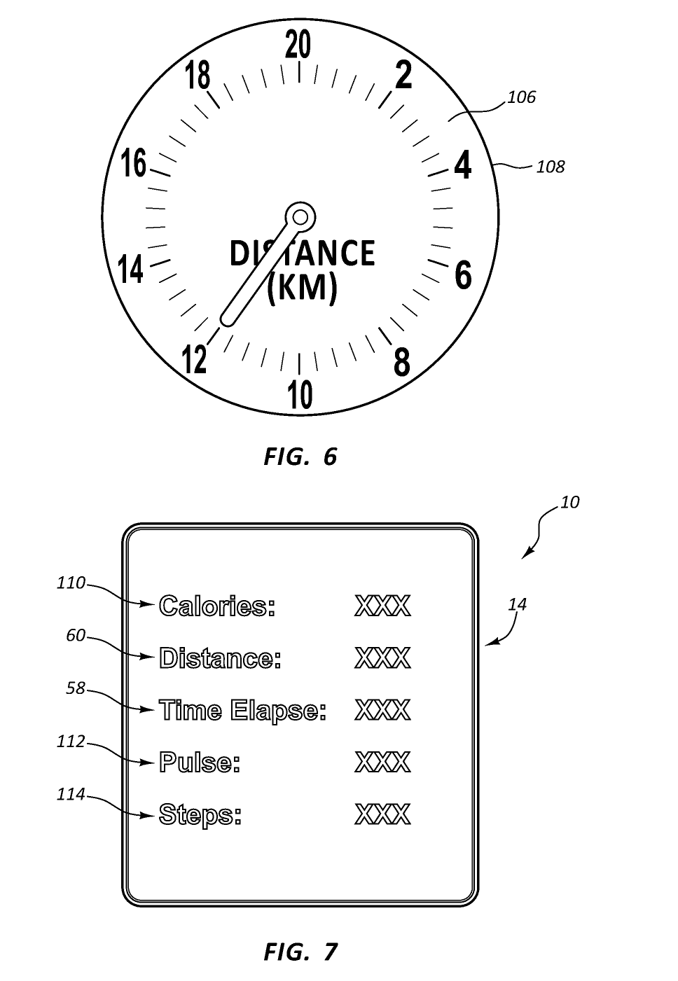

FIG. 6 illustrates a front view of an example of a wrist watch 10 in accordance with the present disclosure. In this example, a fifth numbered dial 106 is depicted, which may be incorporated into the first face 12 or the second face 14 of the wrist watch 10. In this example, the distance is measured in kilometers and numerical indicators are periodically positioned along a fifth perimeter 108 formed by the fifth numbered dial 106 that corresponds to the number of kilometers traveled. However, numerical indicators may represent any appropriate unit of distance. For example, the numerical indicators may represents meters, yards, miles, feet, other units of distance, or combinations thereof.

FIG. 7 illustrates a front view of an example of a wrist watch 10 in accordance with the present disclosure. In this example, the second face 14 of the wrist watch 10 displays a digital calorie indicator 110, a digital distance indicator 60, a digital time indicator 58, a digital pulse indicator 112, and a step indicator 114. Each of these indicators may be used during a workout or another time period that overlaps at least in part with the time period tracked with the first face 12. Each of these parameters may be started and/or stopped simultaneously with a single command from a button or audible command. In other examples, one or more of the above-mentioned indicators may start or stop independently of the others.

In some examples, the arrangement of the second face 14 may be customized based on user input. Further, the second face 14 may track more information than is convenient for a user to view at once due to the size limitations of the second face 14. In such examples, the second face 14 may include multiple layers that display different parameters and the user may shift between the different layers or displays. For example, the user may desire to view the time parameters while performing a sprint exercise. At the conclusions of the sprint exercise, the user may bring a different layer to the foreground to view the recorded information. For example, the user may view the number of calories burned during the sprint as well as the pulse rate by giving a command to the second face 14 to display this information while sending the time indicators into the background.

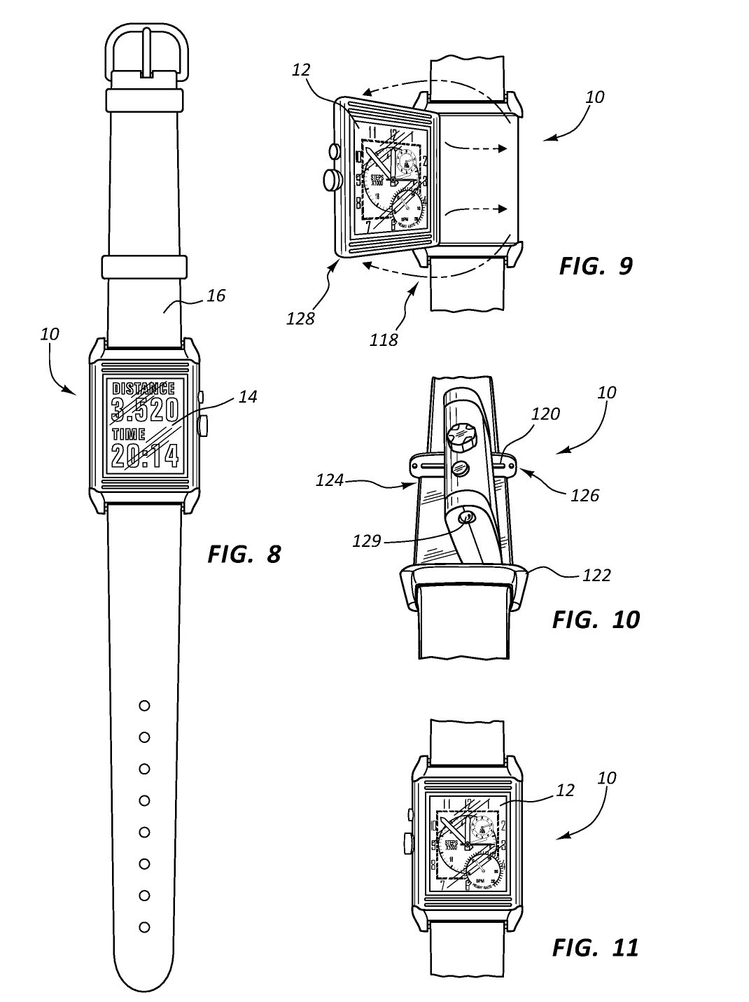

FIGS. 8-11 depict an example of a wrist watch 10 with a watch portion 116 that has the first face 12 and the second face 14. The watch portion 116 is connected to the wrist band 16 in such a manner that the either the first face 12 or the second face 14 can be exposed while the other is concealed. In the illustrated examples, the watch portion 116 is depicted with a pivot side 118 that has a pivot attachment, such as a rod or protrusion, that extends from the watch portion 116. An exposed end of the pivot attachment can be disposed within a track 120 formed in a holder 122 attached to the wrist band 16. The watch portion 116 can slide along the length of the track 120 such that the pivot side 118 of the watch portion 116 can be on either a first side 124 or a second side 126 of the track 120. A latch side 128 of the watch portion 116 is opposite of the pivot side 118. The latch side 128 incorporates a detent 129 that allows the watch portion 116 to interlock with a holder 122 as the watch portion 116 is made to be aligned with the holder 122.

Such an arrangement allows a user to switch which face of the watch portion 116 is exposed while simultaneously concealing the other. A user may rotate the watch portion 116 up about the pivot attachment and slide the watch portion 116 down the track 120 until the pivot side 118 of the watch portion 116 is at a different end of the track 120. The user may then rotate the watch portion 116 down about the pivot attachments such that the latch side 128 is secured to the holder 122.

While this example has been described with a particular arrangement for switching which face is positioned for the use, any appropriate arrangement may be used to allow a user to switch the faces. For example, the wrist watch 10 may include a centrally located pivot attachment. In another example, the watch portion 116 may snap out of a holder 122 attached to the wrist band 16 and be constructed to snap back into the holder 122 with either the first face 12 or the second face 14 up.

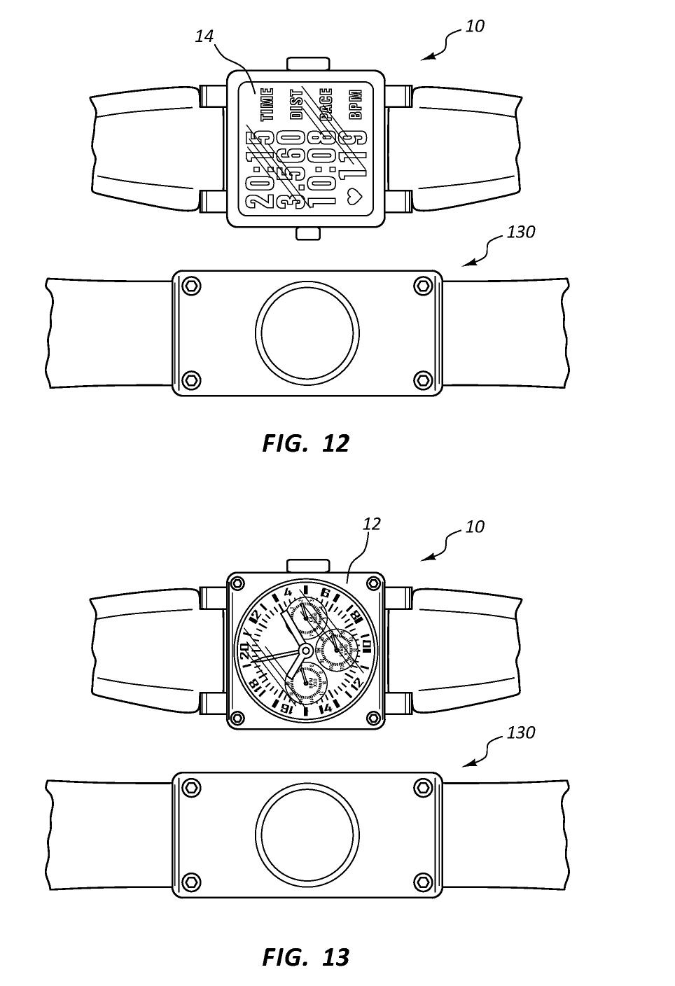

FIGS. 12 and 13 depict wrist watches 10 with either the first face 12 or the second face 14 positioned for use with respect to the wrist band 16. These wrist watches 10 are configured to be in communication with an accessory 130 that can be in communication with the wrist watch 10. In the illustrated examples, a heart rate monitor is depicted as being in communication with the wrist watches 10. However, other accessories can be in communication with the wrist watches 10, such as pedometers, motion detectors, speedometers, blood pressure monitors, electrocardiogram electrodes, other types of electrodes, global positioning units, mobiles devices, smart phones, other watches worn by other users, other types of sensors configured to measure a physiological parameter of a user, other types of accessories, or combinations thereof. Such accessories may be used to communicate data to the wrist watch 10 that can be used to at least assist with determining the appropriate measurement to display in either the first or the second watch faces 12, 14. Further, the accessories may be arranged to track information obtained from the wrist watch 10. In some cases, such obtained information may transmit the data to a central location storage device, perform calculations, perform another task with the data, or combinations thereof.

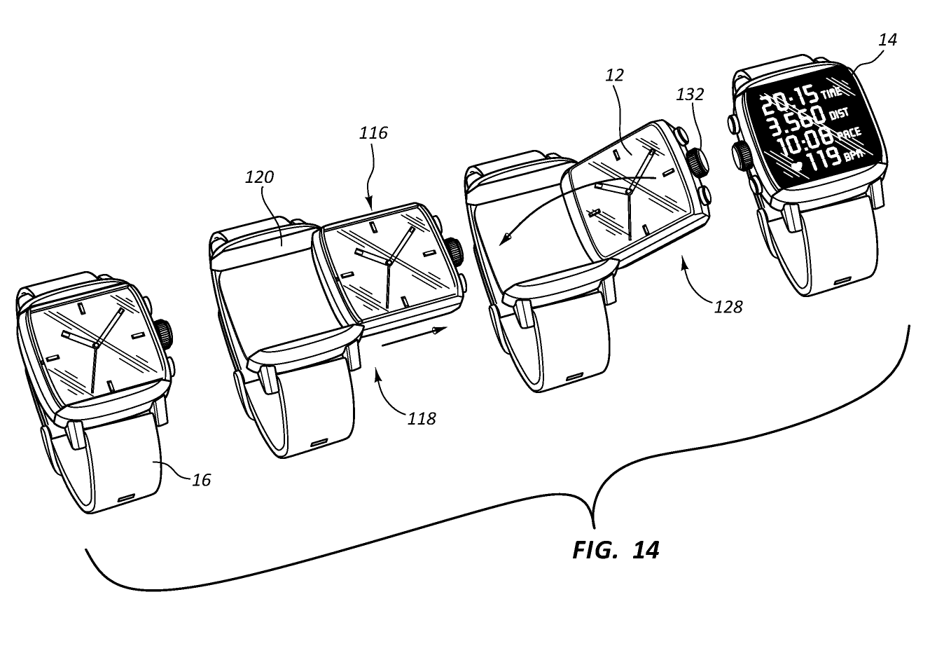

FIG. 14 illustrates a front view of an example of a wrist watch in process of switching between a first face and a second face in accordance with the present disclosure. In this example, the watch portion 116 is connected to the wrist band 16 on a pivot side 118. The pivot side 118 is configured to slide within the track 120 formed in a holder 122 attached to the wrist band 16. The pivot side 118 can pivot such that either the first face 12 of the watch portion 116 or the second face 14 of the watch portion 116 is facing outward while the other face is concealed within the holder 122. To switch between the first face 12 and the second face 14, the latch side 128 of the watch portion 116 may be detached from the wrist band 16. The watch portion 116 may then slide with either of the first or second face 12, 14 facing upward while the latch side 128 is detached. When the watch portion 116 is aligned with the wrist band 16 with the appropriate face positioned outward, the latch side 128 can be reattached to the wrist band 16.

Any appropriate mechanism for attaching the latch side 128 to the holder 122 may be used in accordance with the principles described in the present disclosure. In some examples, a locking component, such as a detent, is formed on the holder 122 which is configured to interlock with the watch portion 116. In other examples, the detent is formed in the watch portion 116 and is configured to interlock with the holder 122. In other examples, a magnetic component may be included in either the holder 122 or in the watch portion 116. In such an example, as the magnetic component is brought closer to the holder 122 or the watch portion 116, the magnetic component magnetically attracts the holder 122 or the watch portion 116 and holds the holder 122 or watch portion 116 in place through a magnetic connection. In yet another example, the size and/or shape of the watch portion 116 may be compressively held between the inner walls 125 of the holder 122. Such a compression fit may secure the watch portion 116 to the holder 122.

In some examples, both the first face 12 and the second face 14 have electrically conductive contacts that are arranged to make a fingertip contact with the user. Thus, when the first face is exposed, a first contact of the first face 12 will be positioned to make the fingertip contact. Likewise, when the second face is exposed, a second contact of the second face 14 will be positioned to make the fingertip contact. However, when either the first or second contact is positioned to make the fingertip contact, the other electrically conductive contact is concealed within the holder. A portion of the holder 122 may include an electrically conductive portion that touches the concealed contact of either the first or second face. Thus, an electrical signal can pass from the concealed contact to the electrically conductive portion of the holder 122 and vice versa.

The electrically conductive contacts can be used to detect electrical signals of the body. For example, a cardiac signal emitted by the user's body can involve an electrical signal that can be detected through the electrically conductive contacts if at least two portions of the user's skin are in electrical contact with both of the electrical contacts simultaneously. In the example of FIG. 14, the electrically conductive portion of the holder 122 can be the floor 123 of the holder 122 which can make contact with the user's skin on his arm, wrist, or hand. The user can place his fingertip against the exposed contact. Such an arrangement allows for electrical contact to be made simultaneously with both the first and second electrical contacts because the electrically conductive floor 123 of the holder 122 passes the skin's electrical stimulus to the concealed electrical contact. While the above example has been described with reference to detecting a cardiac signal, the principles described above may be applied to detecting other electrical parameters about the user.

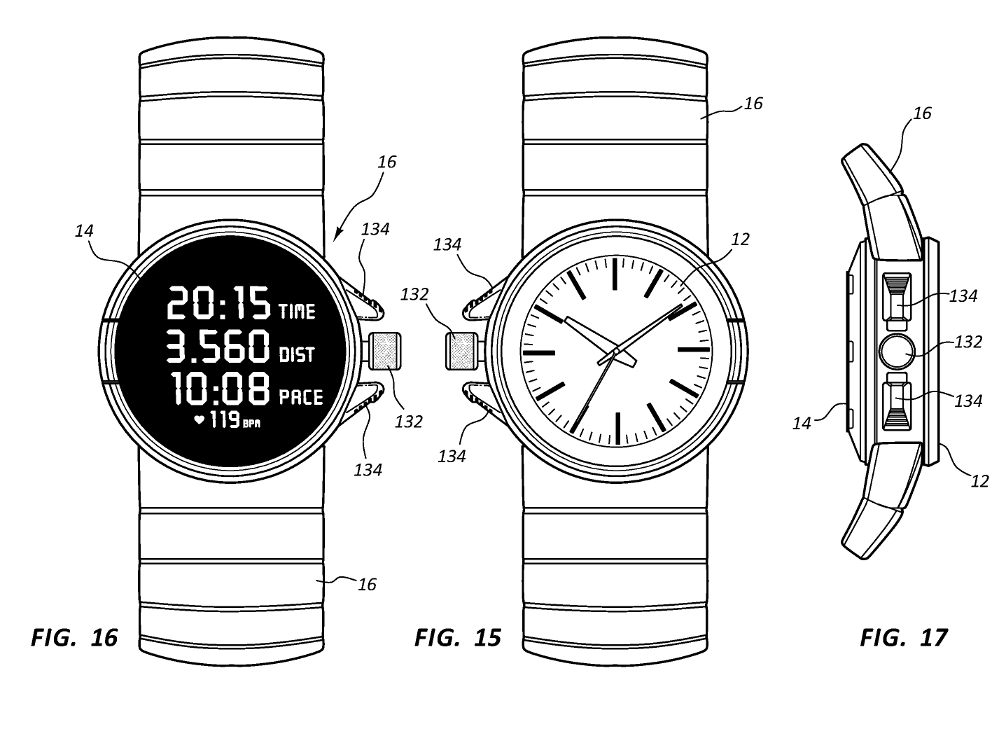

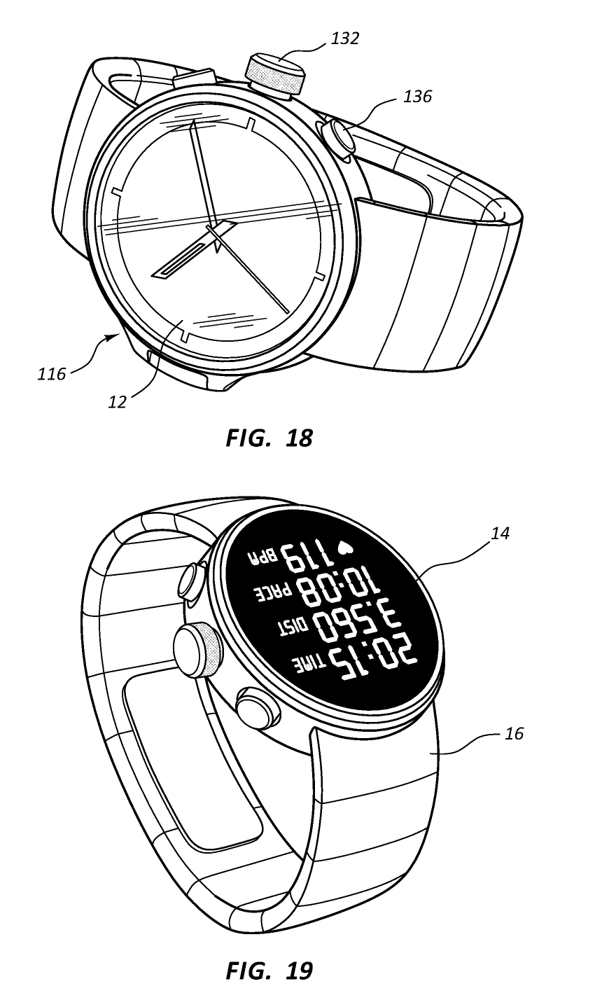

FIGS. 15-17 illustrate an example of a wrist watch 10 in accordance with the present disclosure. In this example, the second face 14 of the wrist watch 10 tracks a time duration, a distance, a pace, and a heart rate in a digital format. The first face 12 tracks a time of day with a numbered dial. Any of these parameters may be modified, reset, or otherwise changed with a rotary dial 132 incorporated into the watch portion 116. In other examples, buttons may be used to modify at least one of the these parameters. In the illustrated example, the rotary dial 132 is surrounded with protruding sliders 134 that can be used to provide various types of input into the wrist watch 10.

The rotary dial 132 may be used to control any appropriate mechanism or task of either of the first face 12 or the second face 14. For example, the rotary dial 132 may be used to control a mode of the wrist watch 10, to reset a timer, to change a time parameter, to modify personal data inputted into the wrist watch 10, to reset the tracking of a physiological parameter, to send data to a remote computing device, to select to which remote computing device to send information, to activate a backlight of the wrist watch 10, to silence an alarm of the wrist watch 10, to perform another task, or combinations thereof. In some examples, the rotary dial 132 is used to control parameters that are tracked in a digital format, a numbered dial format, another type of format, or combinations thereof. Additionally, the lengthwise position and rotary position of the rotary dial may allow the user to give different types of commands.

For example, the inward most lengthwise position of the rotary dial 132 may be for selecting a time of day parameters on a first face 12 of the wrist watch 10. Such a parameter may be presented through a numbered dial. If such a parameter is selected, the values assigned to that parameter may be increased or decreased depending on the direction that the rotary dial 132 is rotated. As the rotary dial 132 is rotated, the pointer associated with the numbered dial may move to the appropriate new value.

In an intermediate lengthwise position, the rotary dial 132 may be positioned to adjust a calorie count that is tracked on the second face 14 of the wrist watch 10 in a digital format. In such an example, the calorie count may be reset by turning the rotary dial 132.

In a distal most position, the rotary dial 132 may be used to input user data. As questions are presented to the user about his or her personal information, such as weight, height, age, gender, and so forth, the user may answer the questions by rotating the rotary dial 132 in appropriate directions or laterally actuating the rotary dial 132, thereby selectively engaging a digital input button (not shown).

While these examples have been described with reference to specific lengthwise positions associated with specific tasks, any appropriate type of lengthwise position may be associated with any appropriate type of task. Further, any number of lengthwise positions may be used. Additionally, other input mechanisms may be incorporated into the watch that may be used in conjunction with the rotary dial 132. For example, a button may be incorporated into the wrist watch 10, which may be used to select the tasks, increment values, decrement values, activate lights and/or alarms, perform other tasks, or combinations thereof.

Also, in the illustrated example, the wrist band 16 is a metal wrist band. However, any appropriate type of wrist band may be used in accordance with the principles described in the present disclosure. For example, a non-exhaustive list of wrist bands that may be used include leather bands, stainless steel bands, titanium bands, caoutchouc bands, textile bands, nylon bands, synthetic bands, gold bands, metal bands, silver bands, aluminum bands, mesh bands, expansion bands, silicone bands, Velcro bands, clasp bands, strap bands, other types of bands, or combinations thereof.

FIGS. 18-19 illustrate an example of a wrist watch 10 in accordance with the present disclosure. In this example, the wrist watch 10 includes a generally circular watch portion 116. Further, the watch portion 116 includes a metal wrist band 16, a rotary dial 132, side buttons 136 for inputting information, and other features.

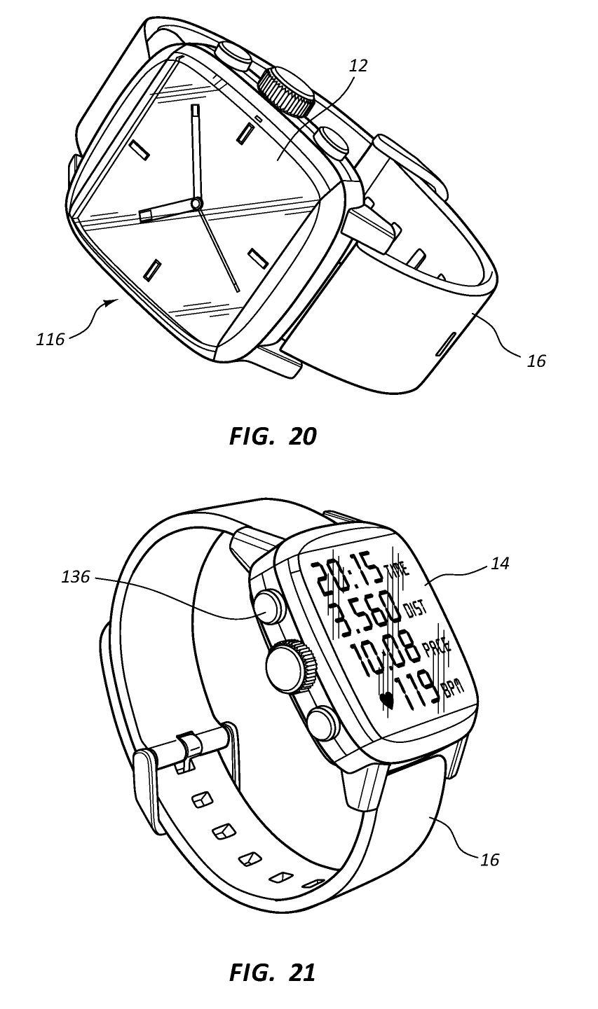

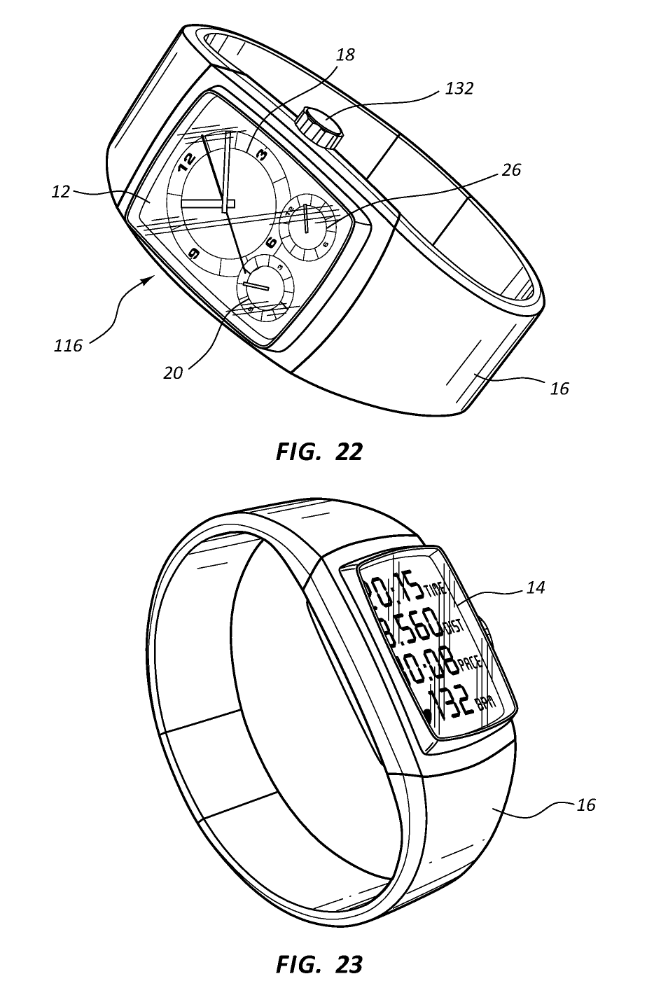

FIGS. 20-21 illustrate an example of a wrist watch 10 in accordance with the present disclosure. In this example, the wrist watch 10 includes a generally rectangular watch portion 116. Further, the watch portion 116 includes a metal wrist band 16, a rotary dial 132, side buttons 136 for inputting information, and other features.

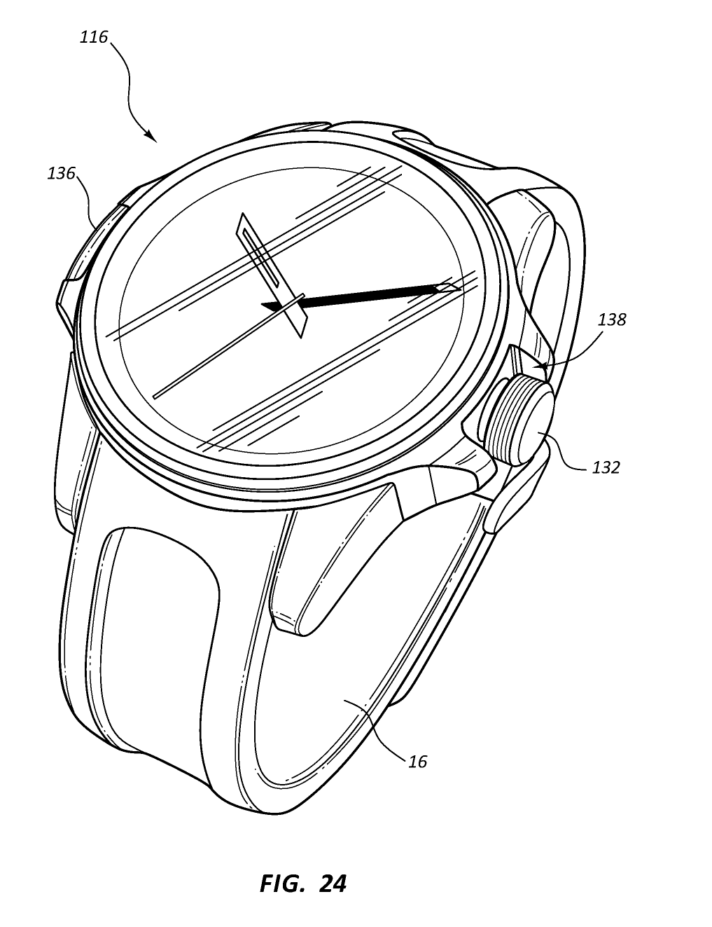

FIGS. 22-23 illustrate an example of a wrist watch 10 in accordance with the present disclosure. In this example, the first face 12 includes a first numbered dial 18, a second number dial 20, and a third numbered dial 26, each of which is tracking a different parameter. At least one of these parameters may be a time parameter. Further, at least one of these parameters may be a physiological parameter. In this example, a single rotary dial 132 protrudes from the watch portion 116. Further, in this example, the wrist band 16 has a similar width as the watch portion 116 where the watch portion 116 and the wrist band 16 join. In some examples, the wrist band 16 narrows as it progresses away from the watch portion 116. In other examples, the wrist band 16 has a uniform width along the entire length of the wrist band 16.

FIG. 24 illustrate an example of a wrist watch 10 in accordance with the present disclosure. In this example, the watch portion 116 has a generally circular shape. Additionally, the watch portion 116 includes a rotary dial 132 that protrudes out of a recess 138 of the watch portion 116. On an opposing side of the watch portion 116, a button 136 is positioned for inputting information into the watch portion 116.

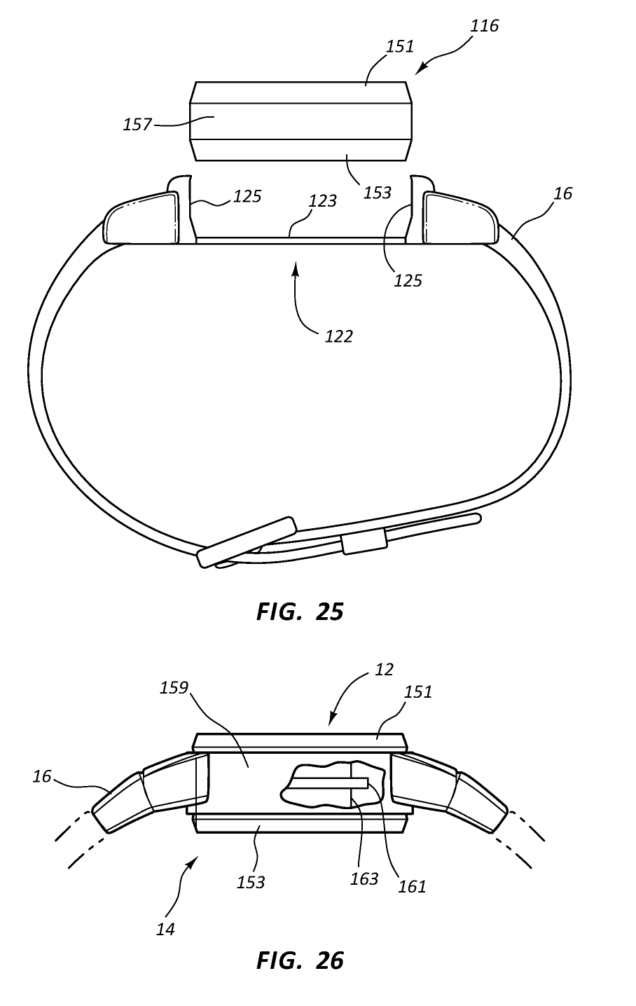

FIG. 25 illustrate an example of a wrist watch 10 in accordance with the present disclosure. In this example, the watch portion 116 is shown apart from the holder 122. In some examples, the watch portion 116 pivots into place within the holder 122. However, in other examples, the watch portion 116 slides into place within the holder 122, snaps into place within the holder 122, is completely removable from the holder 122, or combinations thereof.

The holder 122 has an electrically conductive floor 123 and electrically insulating inner walls 125. The watch portion 116 has a first electrically conductive contact 151 incorporated into the first face 12, and a second electrically conductive contact 153 incorporated into the second face 14. When the watch portion 116 is secured within the holder 122, whichever of the first or second electrical contact 151, 153 is concealed can make an electrical connection with the electrically conductive floor 123 of the holder 122. As a result, an electrical signal from the electrically conductive floor 123 can be detected at the concealed electrical contact.

An electrically insulating material 157 incorporated into the watch portion 116 prevents a signal from the concealed electrical contact or from the floor of the holder 122 from being shorted to the exposed electrical contact. Further, the electrically insulated inner walls 125s of the holder also prevent shorting between the electrical contacts 151, 153.

When a user places his fingertip on the exposed electrical contact, an electrically circuit is completed. The circuit includes the human body (the skin of the fingertip and wrist), the exposed electrode, an internal electrically conductive pathway between the exposed and concealed electrodes, the concealed electrode, and the holder 122. The electrical signals can be measured along the internal electrically conductive pathway to determine the heart rate activity of the user. Any appropriate type of electrical measurement may be read off of the internal electrically conductive pathway, such as a voltage differential, an electrical current, a resistance, or another type of electrical characteristic or combinations thereof.

Alternatively, according to one embodiment, the electrical signals of the user indicative of the user's pulse or other measurable parameters may be gathered entirely from the electrically conductive floor 123 of the holder 122 without fingertip contact. According to this embodiment the electrically conductive floor 123 includes multiple contacts that, when in contact with the user's skin, complete a circuit configured to measure changes in electrical resistance generated by pulse and other measurable physiological parameters.

FIG. 26 illustrate an example of a wrist watch 10 in accordance with the present disclosure. In this example, the watch portion 116 includes the first electrically conductive contact 151 and the second electrically conductive contact 153. The material of the watch portion's outer surface 159 is made of electrically insulating material to prevent an electrical short between the first and second electrically conductive contacts 151, 153. A circuit reader 161 is positioned along the internal electrically conductive pathway 163 that electrically connects the first and second electrically conductive contacts 151, 153 within the watch portion 116. The circuit reader 161 can output the measurements in the appropriate watch face to present the measured heart rate.

While the above examples have been described with reference to particular watch portion shapes, any appropriate watch portion shape may be used in accordance with the principles described herein. For example, the watch portion shapes may include generally circular shapes, generally rectangular shapes, generally square shapes, generally triangular shapes, generally star shapes, generally polygonal shapes, other shapes, or combinations thereof.

### INDUSTRIAL APPLICABILITY

In general, the invention disclosed herein may provide a user with a mechanism to track time parameters and physiological parameters with a single device that is constructed for multiple types of settings, such as professional settings, social settings, workout settings, other types of settings, and combinations thereof. The wrist watch may include two faces, a first face that is constructed to be appropriate for professional type settings and the like, and a second face that is constructed to be appropriate for workout settings and the like.

The wrist watch may be constructed to track both time parameters and physiological parameters on a single face or both faces. Time parameters may include a time of day, a countdown timer, a stopwatch, another type of time parameter, or combinations thereof. The physiological parameters may include a body movement count, a step count, an arm movement count, a pulse rate, a breathing rate, a heart rate, a distance traveled, a calorie count (or a count of another unit of energy), another type of physiological parameter, or combinations thereof. In some examples, there is overlap between the parameters tracked with the first face and the second face while in other examples there is no overlap.

The first face, which may be constructed to be appropriate for professional settings and the like, may include numbered dials to convey at least one of the tracked parameters. However, the first face may include other types of tracking mechanisms that convey the tracked parameters in a manner that is appropriate for professional settings. The second face, which may be constructed to be appropriate for workout settings, may include a digital mechanism for conveying at least one of the tracked parameters. In some embodiments, the second face includes other types of mechanisms for tracking the parameters in a manner that is appropriate for a workout setting. However, numbered dials, digital mechanisms, and other types of mechanism for tracking the parameters may be included on a common face of the wrist watch.

The principles described in the present disclosure are directed towards a wrist watch which has a first face and a second face. The first face can be opposite to the second face so that the first face is exposed or facing outward when the second face is concealed against the user's wrist or vice versa. Each face is arranged to track at least one parameter. The wrist watch can display a time parameter with one of the faces while displaying a physiological parameter in the other. However, any appropriate type or number of parameters may be tracked and/or displayed by either face including time parameters, location parameters, physiological parameters, environmental parameters, or combinations thereof.

In some aspects, the wrist watch includes that one of the faces has a different look than the other face. For example, one face may have a classy look that is appropriate to wear in business settings, social settings, or other types of settings, while the other face has a functional look that is more appropriate for workout settings. The classy look may include non-digital formats to track the time and/or physiological parameters. The functional look may include features that allow the user to quickly ascertain the information presented in that particular face, such as digital numbers, illuminated numbers, or other features.

Additionally, the wrist watch may be in communication with remote computing devices. For example, the wrist watch may receive information from a remote computing device, such as a heart rate monitor or another type of physiological sensor. The wrist watch may display in the appropriate face or faces the information received from the physiological parameter. In other examples, a physiological sensor, such as a heart rate monitor, may be incorporated into the wrist watch, and the wrist watch displays the information gathered from its sensor in the appropriate face or faces. The wrist watch may also be arranged to send information gathered or received by the wrist watch to a remote computing device. For example, information about the user's workout may be sent to a fitness tracking device where the information about the user's workout can be stored in a format that can be accessed by the user.

Also, an input mechanism incorporated into the watch can be used to control tasks involving both faces of the watch. For example, a rotary dial incorporated into a side of the wrist watch may be used to input information into the watch, reset a parameter tracked in either face, increment or decrement a value of a tracked parameter, perform another function, or combinations thereof.

Any appropriate format may be used to present the tracked parameters. For example, the physiological parameters may be tracked in a digital format. However, in other example, the physiological parameters are tracked in a non-digital format. Such a non-digital format for presenting the tracked physiological parameters may include a numbered dial with a pointer. The numbered dial may form a perimeter, form a straight line, form a curved line, take another form, or combinations thereof.

1-108. (canceled)

109. A wrist watch, comprising:
a first face with a first display configured to track a physiological parameter; and
a second face with a second display configured to track a first time parameter.

110. The wrist watch of claim 109, further comprising:
the first face and the second face are incorporated into a watch portion where the watch portion is connected to a wrist band;
the watch portion being pivotally connected to the wrist band on a pivot side of the watch portion;
the pivot side is arranged to slide along a track of the wrist band; and
the watch portion further comprising a latch side opposite of the pivot side that is arranged to interlock with the wrist watch.

111. The wrist watch of claim 109, wherein the first face or the second face is further configured to track a distance parameter.

112. The wrist watch of claim 109, wherein the second face is further configured to track a second time parameter.

113. The wrist watch of claim 109, further comprising a transmitter constructed to be in wireless communication with a network.

114. The wrist watch of claim 113, wherein the network comprises a storage device that is capable of storing data sent from the wrist watch.

115. The wrist watch of claim 109, wherein the first face comprises a first display configured to track the physiological parameter in a non-digital format.

116. The wrist watch of claim 109, further comprising an input mechanism that controls at least one aspect of the first face and the second face.

117. The wrist watch of claim 116, wherein the input mechanism is a rotary dial.

118. The wrist watch of claim 109, wherein the physiological parameter is a heart rate parameter.

119. The wrist watch of claim 109, wherein the physiological parameter is a body movement count.

120. The wrist watch of claim 109, wherein the physiological parameter is a calorie count.

121. The wrist watch of claim 109, wherein the first face includes a numbered dial forming a perimeter and a pointer configured to track a body movement count.

122. The wrist watch of claim 109, wherein the first face includes a numbered dial forming a perimeter and a pointer configured to track a calorie count.

123. The wrist watch of claim 109, wherein the first face includes a numbered dial forming a perimeter and a pointer configured to track a step count.

124. The wrist watch of claim 109, further comprising a multi-axis accelerometer capable of distinguishing between stepping movements and arm movements.

125. The wrist watch of claim 109, wherein the first face includes a numbered dial forming a perimeter and a pointer configured to track the physiological parameter.

126. A system, comprising:
a wrist watch with a watch portion and a wrist band;
the watch portion comprising a first face and a second face;
the first face comprising a display that presents at least one tracked time parameter;
a processor;
memory in communication with the processor, the memory being programmed with instructions that are executable by the processor to:
present at least one physiological parameter of a user in the second face; and
wirelessly communicate with a network.

127. The system of claim 126, wherein the network comprises at least one storage device capable of storing data sent from the wrist watch.

128. A wrist watch, comprising:
a first face with a first display configured to track a heart rate parameter and a first time parameter;
a second face with a second display configured to track a second time parameter with a numbered dial forming a perimeter and having a pointer;
a transmitter constructed to be in wireless communication with a network;
the first time parameter and/or the second time parameter is selected from a group of a time of day, a stopwatch, a timer, and combinations thereof; and
the first face or the second face is further configured to track a distance parameter.
